(19) United States
(12) Patent Application Publication
(10) Pub. No.: US 2002/0180169 A1
(43) Pub. Date: Dec. 5, 2002

(54) Kick boards

(76) Inventor: Chun Lung Kwok, Hong Kong (HK)

Correspondence Address: INTELLECTUAL PROPERTY LAW OFFICE, 1901 S. BASCOM AVENUE, SUITE 660, CAMPBELL, CA, 95008, US

(21) Appl. No.: 09/874,541

(22) Filed: Jun. 4, 2001

(51) Int. Cl. B62M 1/00

(52) U.S. Cl. 280/87.041; 280/14.28

(57) ABSTRACT

A handle of a kick board is hingably connected to a chassis of a front truck of the kick board. The hinge connection consists of a lower connector fixed to the chassis and an upper connector fixed to a lower end of the handle. The connectors have co-operating vertical surfaces that constrain folding movement of the handle through a vertical plane and are held pivotably together by a sleeve pin. The hinge connection is locked by engaging a spring biassed plunger into a suitably formed vertical slot in the lower connector. The lock is released by raising the plunger by sliding a manually grippable sheath upwards along the handle so as to move a pin, that passes through the plunger, upwards.

### BACKGROUND OF THE INVENTION

1. Field of the Invention

The invention relates to kick boards.

2. Description of Prior Art

Kick boards are already widely available and comprise an elongate flex deck (or platform) with two wheels fitted at the front of the flex deck and one wheel at the rear. A rigid upstanding handle, usually in the form of a telescopic pole, is mounted adjacent the front of the deck. A rider stands on the deck and steers by tilting the deck left or right relative to the ground while resting his weight on the deck and pushing or pulling sideways on the handle.

Kick boards may be used for personal transport, simple recreational activities or for kick board competitions. It is imperative, especially for the last activity, to arrange for the handle to be sturdy and rigidly attached to the deck because the joint between the handle and the deck must be capable of resisting considerable stresses. However, it is also a requirement, for ease of transport and storage, that the handle can fold against and over the deck. Presently provided hinges for the handle do not meet these criteria in a totally satisfactory manner.

### SUMMARY OF THE INVENTION

It is an object of this invention to overcome or at least reduce this problem.

According to the invention there is provided a kick board having a front truck with a pair steerable wheels, an elongate flex deck extending from the truck to a rear wheel, and a foldable handle pivotably connected to a chassis of the front truck to allow the handle to move through a vertical plane from a substantially vertical position above the chassis to a substantial horizontal position overlying the deck, in which a hinge connection to allow the handle to pivot comprises a lower connector anchored to the chassis and having opposing vertical planar outer surfaces, a forked upper connector that fits over the lower connector and is attached to a lower end of the handle, the upper connector having vertical planar inner surfaces that fit snugly and slidingly against the respective outer surfaces of the lower connector, a pivot pin extending through the inner and outer vertical surfaces to hold the lower and upper connectors together, and a manually releasable lock that prevents relative rotation between the connectors and pivoting of the handle to fold over the deck whenever the handle is in the vertical position.

The lock may comprise a vertical slot in an upper surface of the lower connector and a spring biassed plunger constrained to slide inside the upper connector and fit snugly into the slot.

The slot and plunger are preferably correspondingly tapered, and a wedge formed by the tapering on the plunger having a principal axis that extends in a plane at right angles to a longitudinal axis of the deck.

An external manually grippable sheath may be provided that is slidable over an outside of the lower end the handle and a fixed pin extending from the sheath to mechanical connect to the plunger, the plunger being movable against its bias to unlock the handle and allow the handle to pivot when the sheath is slid relative to the handle.

The lower connector preferably has a second slot extending horizontally into a rear facing surface thereof, the second slot being engaged by the plunger for locking the handle in the horizontal position.

The handle may comprise a hollow tube and the lock include a lock plunger bush that fits inside the tube to firmly and slidably locate the plunger with respect to the upper connector.

### BRIEF DESCRIPTION OF THE DRAWINGS

A kick board according to the invention will now be described by way of example with reference to the accompanying drawings in which:

FIG. 1 is an isometric view of the kick board in a folded configuration;

FIG. 2 is an exploded isometric view of a handle hinge arrangement for the kick board;

FIG. 3 is a sectional elevation of the handle in an upright vertical position viewed from a side of the kick board;

FIG. 4 is a sectional elevation of the handle in an upright vertical position viewed from the front of the kick board.

FIG. 5 shows a side view of connectors for the kick board; and

FIG. 6 show a cross sectional end view of the connectors.

### DESCRIPTION OF THE PREFERRED EMBODIMENTS

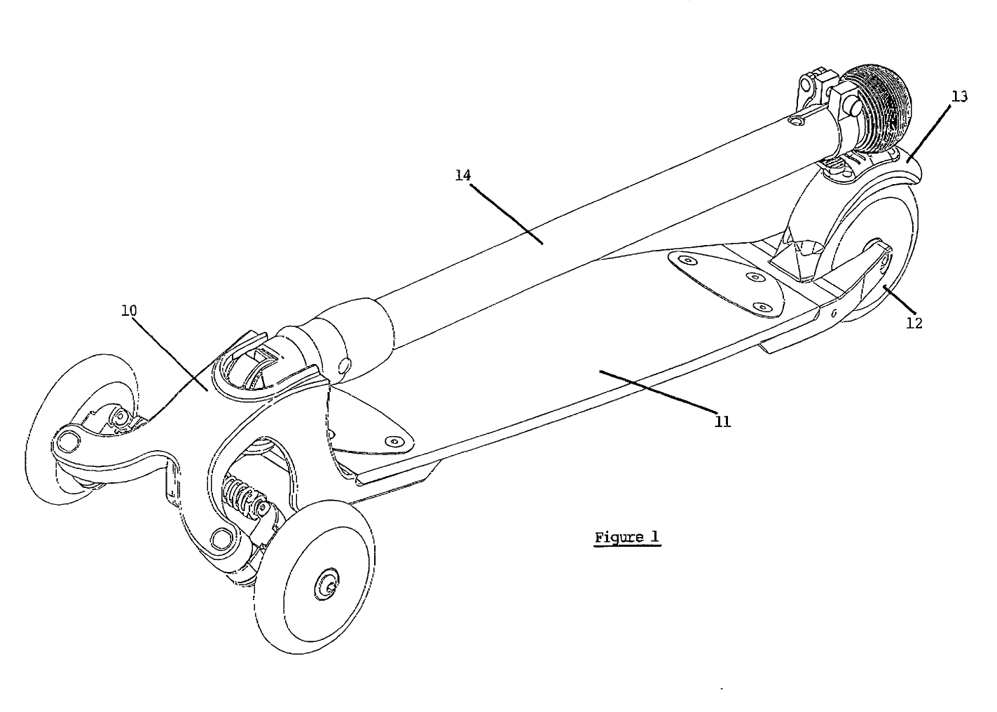

Referring to the drawings, in FIG. 1 the kick board has a two wheeled front truck including a chassis 10 that is rigidly connected to a forward end of an elongate flex deck 11. A single wheel 12 is mounted at a rear end of the deck 11 below a pivoted mudguard/foot brake 13. A telescopic tubular handle 14 is pivotably mounted to the chassis 10. The handle can pivot from a horizontal position, shown in the Figure, through a vertical plane to a vertical position for normal use. The kick board is steered by tilting the deck 11, by pushing or pulling sideways on the handle, to cause the front wheels to automatically turn in the direction of the tilt. The handle is also used to lift and spin the kick board to carry out manoeuvres or ‘stunts’. Generally stated, the kick board so far described is already well-known.

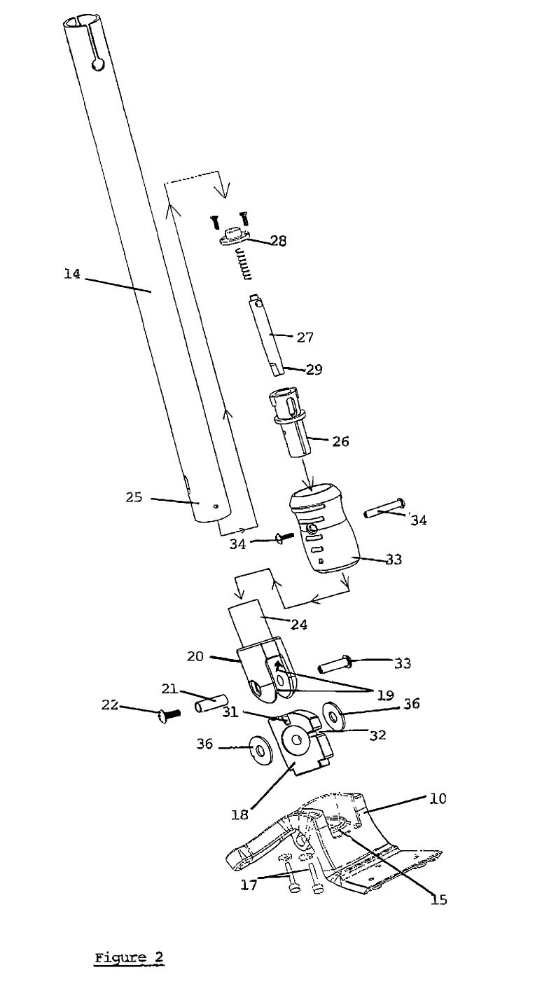

However, the handle and especially its hinged or pivoted connection to the kick board requires certain characteristics that are so far not available, or not adequately available, for convenience and to ensure safe operation during use of current kick boards. In FIGS. 2, 3, 4, 5 and 6, a new hinge arrangement for the handle is provided and described below.

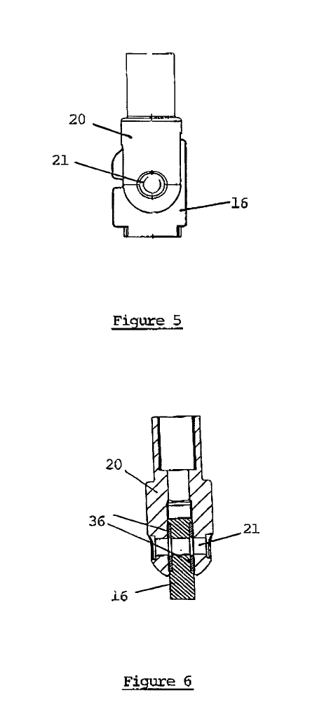

The chassis 10 has a shaped anchor plate 15, for receiving a lower connector 16 that is located against and in the plate 15, which is screwed to the chassis by screws 17. The lower connector has opposing vertical planar outer surfaces 18 that are received between vertical planar inner surfaces 19 of an upper connector 20. A pivot sleeve pin 21 extends through the vertical surfaces to hold the connectors 16 and 20 together (see also FIGS. 5 and 6). Male and female screws 22 and 23 hold the pin 21 in position. A boss 24 formed on the upper connector 20 is attached inside a lower end 25 of the handle 14 by sprung pins (not shown).

A lock for the handle 14 is provided by a bush 26 that fits inside the boss 24 and sliding supports a spring biassed plunger 27 that is held down by a top cap 28. The plunger 27 has a tapered lower end 29 to form a wedge that has a principal axis extending laterally across a longitudinal axis of the deck. Suitably shaped slots 30 and 31 forming part of the lock are provided in a top surface and a side surface of the lower connector 18 respectively, to snugly receive the wedge 29 and hold handle either in the vertical position or the horizontal position. The slot 30, especially, is formed to snugly receive at least the whole of the wedge 29 to ensure that the lock remains firmly closed, even when considerable forces are placed on the hinge connection during normal use of the kick board. The slot 30, and possibly the slot 31, is preferably provided with lead-in upper edges to facilitate entry of the plunger into the slot as the handle is moved towards and into the vertical position.

An outer sheath 33 is slidable mounted over the lower end 25 of the handle 14. Screwed pins 34 hold the sheath to the handle 14 and pass through a hole in the plunger 27 and a slot in the bush 26. To release the lock, the sheath 33 must be slid (upwards) along the handle so as to move the pins 34 and raise the plunger 27 against it spring bias out of the slot 30 or 31, as the case may be.

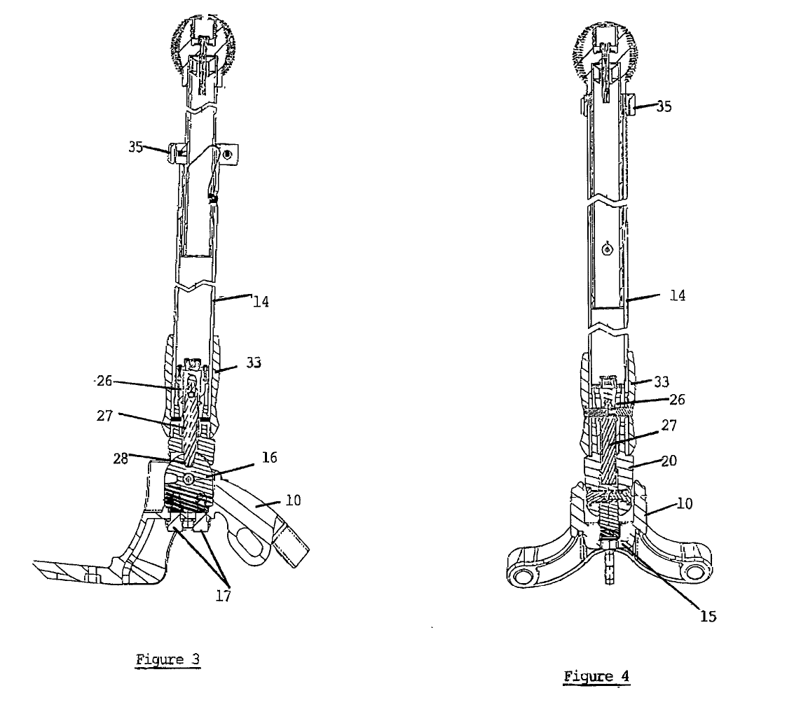

An upper end of the handle 14 has a telescopic connection (see FIGS. 3 and 4) with a manually operable clamp 35 for allowing the handle to be adjusted in length, and securely clamped as required. Such a telescopic connection is already generally known per se.

The principal components of the hinge arrangement and lock (10, 15, 18, 20, 26 and 27) are formed of solid machined parts that ensure that the handle is strongly and firmly held in its principal operative positions. The relatively sliding vertical surfaces 18 and 19 of the upper and lower connectors are formed with relatively large surface areas that are made with close tolerances and held snugly together. As such, and especially when the handle is in the vertical position, the handle is virtually rigidly anchored to the chassis 10 and retained securely in the vertical position. Inset plastic washers 36 keep the bearing vertical surfaces of the lower and upper connectors aligned to maintain snug fitting and prevent jamming when the handle is pivoted. However, the handle remains securely locked and ‘safe’ during normal use.

Preferably throughout travel of the handle, between the vertical and horizontal positions when the lock has been released, pivoting of the handle relative to the chassis is sufficiently stiff, that is there is sufficient frictional resistance and pressure applied between the vertical surfaces 18 and 19, such that the kick board can be carried by the handle. This is provided because it is practically convenient that the kick board can be carried by the handle, but obviously not riden, in any intermediate position of the handle between the vertical position and the horizontal position.

It will be noted that in all positions of the handle and during its folding and unfolding, there are no significant externally exposed gaps that may close up to trap and damage fingers of a user. Also, the release of the lock and folding and unfolding of the handle can be carried out one-handedly by lifting and pressing on the sheath 33. This is done by ‘lifting’ the sheath between the thumb and forefinger to release the lock, and pressing against the lower end of the handle with the palm of the same hand to pivot the handle relative to the chassis.

We claim

1. A kick board having a front truck with a pair steerable wheels, an elongate flex deck extending from the truck to a rear wheel, and a foldable handle pivotably connected to a chassis of the front truck to allow the handle to move through a vertical plane from a substantially vertical position above the chassis to a substantial horizontal position overlying the deck, in which a hinge connection to allow the handle to pivot comprises a lower connector anchored to the chassis and having opposing vertical planar outer surfaces, a forked upper connector that fits over the lower connector and is attached to a lower end of the handle, the upper connector having vertical planar inner surfaces that fit snugly and slidingly against the respective outer surfaces of the lower connector, a pivot pin extending through the inner and outer vertical surfaces to hold the lower and upper connectors together, and a manually releasable lock that prevents relative rotation between the connectors and pivoting of the handle to fold over the deck whenever the handle is in the vertical position.

2. A kick board according to claim 1, in which the lock comprises vertical slot in an upper surface of the lower connector and a spring biassed plunger constrained to slide inside the upper connector and fit snugly into the slot.

3. A kick board according to claim 2, in which the slot and plunger are correspondingly tapered, and a wedge formed by the tapering on the plunger has a principal axis that extends in a plane at right angles to a longitudinal axis of the deck.

4. A kick board according to claim 2, including an external manually grippable sheath slidable over an outside of the lower end the handle, a fixed pin extending from the sheath to mechanical connect to the plunger, the plunger being movable against its bias to unlock the handle and allow the handle to pivot when the sheath is slid relative to the handle.

5. A kick board according to claim 2, in which the lower connector has a second slot extending horizontally into a rear facing surface thereof, the second slot being engagable by the plunger for locking the handle in the horizontal position.

6. A kick board according to claim 2, in which the handle comprises a hollow tube and the lock includes a lock plunger bush that fits inside the tube to firmly and slidably locate the plunger with respect to the upper connector.
